(19) United States
(12) Patent Application Publication
(10) Pub. No.: US 2010/0224384 A1
(43) Pub. Date: Sep. 9, 2010

(54) Portable handheld work apparatus

(75) Inventors: Fabian Gwosdz, Schorndorf (DE); Jan Pawlowski, Waiblingen (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 12/659,278

(22) Filed: Mar. 3, 2010

(30) Foreign Application Priority Data
Mar. 4, 2009 (DE) 10 2009 011 685.0

(51) Int. Cl. B25F 5/00

(52) U.S. Cl. 173/217

(57) ABSTRACT

A portable handheld work apparatus has an internal combustion engine (10) for driving a work tool. The engine (10) has a cylinder (25), a crankcase (26) and an ignition device. The work apparatus has a housing component which is made at least partially from an electrically non-conducting material. At least one electric component is provided on the housing component. The electric component is electrically conductively connected to at least one electric line (69, 70, 71, 72). A simple configuration of the work apparatus and a simple assembly can be achieved when at least one section of the electric line (69, 70, 71, 72) is embedded in the housing component.

### CROSS REFERENCE TO RELATED APPLICATION

This application claims priority of German patent application no. 10 2009 011 685.0, filed Mar. 4, 2009, the entire content of which is incorporated herein by reference.

### FIELD OF THE INVENTION

The invention relates to a portable handheld work apparatus having an internal combustion engine for driving a work tool.

### BACKGROUND OF THE INVENTION

Portable handheld work apparatus driven by internal combustion engines are generally known. Usually, electric components are connected via a connecting cable in portable handheld work apparatus. Connecting cables are complex to place during assembly of the work apparatus. Because of the tight construction space in the work apparatus, the cables must be laid at fixedly pregiven positions in order to ensure that the cables will not become damaged during operation because of vibrations which are generated by the engine.

### SUMMARY OF THE INVENTION

It is an object of the invention to provide a portable handheld work apparatus of the type described above wherein the assembly is simplified and the problem of damage to electric lines is reduced.

The portable handheld work apparatus of the invention includes: a work tool; an internal combustion engine for driving the work tool; the engine including a cylinder and a crankcase connected to the cylinder; the engine further including an ignition system; a housing component made at least partially of an electric non-conductive material; at least one electric line; at least one electric component provided on the housing component and being electrically connected to the electric line; and, the electric line having at least one segment embedded in the housing component.

The electric line is completely surrounded by the material of the housing component because of the embedment of the electric line therein and is thereby protected from ambient influences. Mechanical damage of the electric line can thereby be avoided. The line is embedded already during the manufacture of the housing component so that a subsequent placement of the line during assembly is unnecessary for the embedded segment thereof. In this way, the assembly of the work apparatus is significantly simplified.

Advantageously, the housing component is made at least partially of plastic and the segment of the electric line is injection molded into the housing component. The segment of the electric line is injection molded in the plastic of the housing component. In this way, the placement of the line takes place during injection of the plastic, that is, with the manufacture of the housing component in one work step. A subsequent placement of the line is therefore unnecessary. A simple configuration results when the embedded segment of the electric line is configured as a stamped conductor. Stamped conductors are stamped from sheet metal material and bent as required. Stamped conductors can be easily manufactured and can be placed in the injection molding form during the injection molding process. For contacting the embedded segment of the electric line, at least one contact is arranged on the embedded segment of the electric line and this contact projects out from the material of the housing component for making contact.

Advantageously, at least one contact is configured as a contact blade which functions for connecting to a connecting contact arranged on a connecting component. The contact blade is advantageously aligned in the joining direction of the connecting component. When connecting the component part to the housing component, the connecting contacts of the connecting component are connected to the contact blades because of the joining movement and thereby define an electric connection. An additional work step for making contact is then omitted. In this way, the assembly is significantly simplified. To facilitate joining, it is advantageous to provide a bevel on the end of the contact blade lying forward in the joining direction.

Advantageously, the electric component is a switch which is formed by at least two contacts and a bridging element which is movably journalled on the housing component and coacts with the contacts. A switch of this kind built from the contacts and the bridging element has a simple configuration. The contacts can advantageously be arranged on the stamped conductor so that a simple configuration without additional components results. The contacts are advantageously arranged so as to be mutually adjacent and the bridging element is a conducting cam. In this way, the switch can be built up to be compact. Only a common cam is needed for contacting the two contacts so that a simple assembly results.

The work apparatus is provided to have a pivotally journalled switch shaft with which an operating position, an off position and at least one start position can be set. The bridging element is arranged on the switch shaft. In this way, no additional components are needed for the bridging element. Rather, the switch shaft which is already provided can be used. Advantageously, a latch spring is integrated into the switch shaft and determines the different switch positions of the switch shaft. A simple assembly results when the bridging element with the latch spring is formed as one piece from a bent sheet metal piece.

Advantageously, the housing is the motor housing of the work apparatus. It is provided that at least one operating means tank of the work apparatus is integrated into the motor housing and that at least one embedded segment of an electric line runs in a wall of the operating means tank. An embedded segment of an electric line runs advantageously on the upper side of a fuel tank. In this way, the electric lines, which are usually on the upper side of the fuel tank, can be omitted. Advantageously, the crankcase of the engine is formed on the motor housing.

The electric component is especially a short circuit switch which establishes a connection between at least two contacts in the off position. A first contact is connected to a ground contact and a second contact is connected to the ignition device of the engine. The ground contact is connected to the cylinder of the engine. A simple configuration results when the crankcase has at least one bushing in which an attachment screw is threadably engaged for fixing the cylinder. The segment of the electric line embedded in the motor housing advantageously projects up to the bushing and is connected via the bushing to the cylinder. The electric line is especially embedded between the first contact and the bushing in the motor housing. The ground connection of the short circuit switch can thereby be realized without loose lines completely by a line especially injection molded and embedded in the housing.

The second contact is advantageously connected to a contact blade for connecting to a connecting cable for the ignition device. The electric line is embedded in the motor housing between the second contact and the contact blade. In this way, only the distance between the motor housing and the ignition device, which is usually arranged on the cylinder of the engine, need be bridged by the connecting cable. All other lines, which are needed for the short circuit switch, are embedded in the material of the motor housing and especially injection molded. In this way, a simple robust configuration results. The needed structural space for the connecting lines is significantly reduced.

Advantageously, an electric component is a heating element which is arranged on a heat distribution element. The heat distribution element distributes the heat uniformly in the handle generated by the heating element. In this way, the heating element itself can be configured to be comparatively small. A simple configuration results. The configuration of the work apparatus can be further simplified when at least one segment of the heat distribution element is configured as one piece with an embedded segment of an electric line. The heat distribution element can be configured together with the embedded segment of the electric line as a stamped conductor and be injection molded into the housing component. Here, it is advantageously provided that the heat distribution element mechanically fixes and electrically contacts the heating element. The segment of the heat distribution element, which mechanically fixes and electrically contacts the heating element, projects advantageously out from the material of the housing component. The heat distribution element can be configured as one piece and can be configured as one piece with the stamped conductor. It is, however, also possible to provide a multi-part heat distribution element. For example, respective segments of the heat distribution element can be provided in the handle half shells of the handle. Advantageously, a segment of the heat distribution element is configured as one piece with the stamped conductor and a further segment as a separate component.

The housing component is advantageously a handle housing of a handle. A simple assembly of the handle results when the handle has a connecting plug for connecting to a connecting cable and contact blades for connecting to connecting contacts. All electric lines between the connecting plug, the contact blades and the at least one electric component are embedded in the handle housing. The placement of loose electric lines in the handle housing is then omitted. All necessary electric lines are embedded in the material of the handle housing during manufacture of the handle housing, for example, they are coated with the material of the housing.

### BRIEF DESCRIPTION OF THE DRAWINGS

The invention will now be described with reference to the drawings wherein:

FIG. 1 is a schematic showing a side elevation view of a motor-driven chain saw;

FIG. 2 is a schematic section through the motor-driven chain saw of FIG. 1;

FIG. 3 is a schematic of the cylinder and crankcase of the internal combustion engine of the motor-driven chain saw of FIG. 1;

FIG. 4 is a perspective view, partially in section, of the motor housing of the motor-driven chain saw of FIG. 1;

FIG. 5 is a schematic showing the short circuit switch of the motor-driven chain saw in a first switching position;

FIG. 6 shows the short circuit switch of FIG. 5 in a second switch position different from the first position;

FIG. 7 is a perspective view of an embodiment of the motor housing of the motor-driven chain saw;

FIG. 8 is a perspective view of a brushcutter;

FIG. 9 is a schematic of the electric lines and components arranged in the handle of the brushcutter;

FIG. 10 is a perspective view of a housing half shell of the handle of FIG. 9;

FIG. 11 is a perspective view of the stamped conductors of the handle housing of the brushcutter;

FIG. 12 is an enlarged perspective view of the heating element of the brushcutter; and,

FIG. 13 is a side elevation view of a housing half shell of the handle in the region of the inserted guide tube.

### DESCRIPTION OF THE PREFERRED EMBODIMENTS OF THE INVENTION

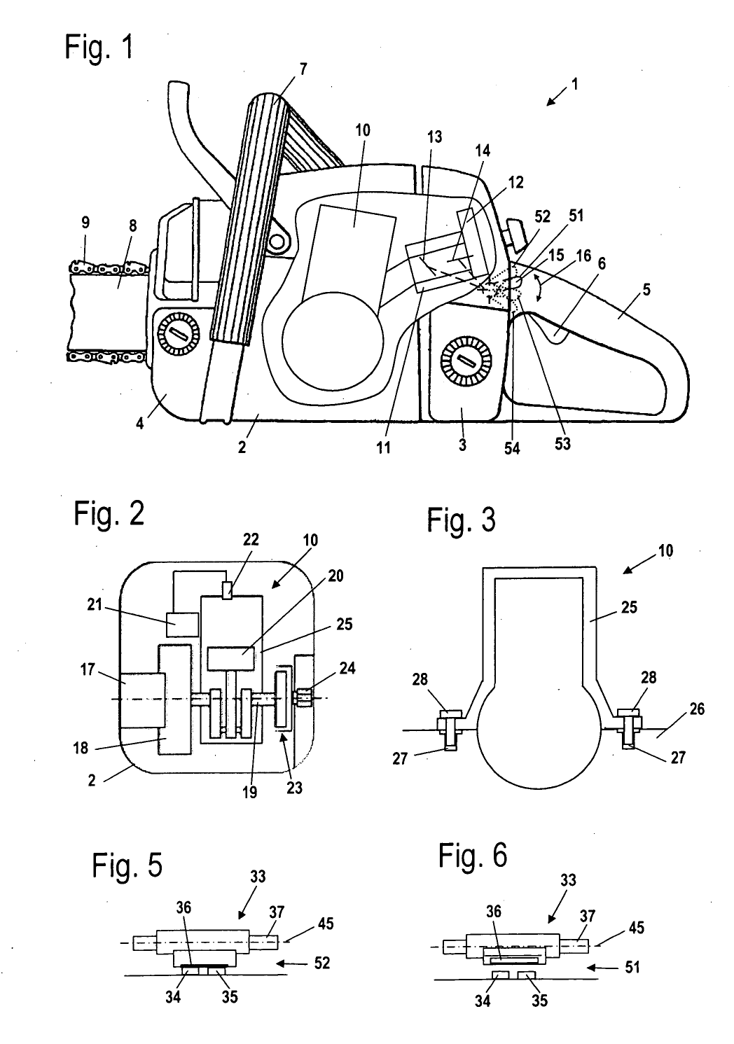

In FIG. 1, a motor-driven chain saw 1 is shown schematically as an embodiment for a portable handheld work apparatus. The motor-driven chain saw 1 has a motor housing 2 on which a rearward handle 5 and a handle tube 7 for guiding the chain saw 1 are attached via antivibration elements (not shown). The motor housing 2 includes a fuel tank 3 as well as a lubricant tank 4. The fuel tank 3 and the lubricant tank 4 are integrated into the motor housing 2. The motor housing 2 is made substantially of plastic and is especially completely made of plastic. The motor-driven chain saw 1 has a guide bar 8 on which a saw chain 9 is driven about the periphery thereof. The saw chain 9 is driven by an internal combustion engine 10 which is mounted in the motor housing 2. A throttle lever 6, which is arranged on the rearward handle 5, serves for operating the engine 10.

The engine 10 has a carburetor 11 on which an air filter 12 is arranged. An air/fuel mixture is drawn by suction by the engine 10 via the air filter 12 and the carburetor 11. An air channel for supplying scavenging advance air can additionally be provided. A throttle flap 13 and a choke flap 14 are pivotally journalled in the carburetor 11. For operating the engine 10, an operator-controlled switch 15 is provided which projects from the housing of the chain saw 1 next to the rearward handle 5. The operator-controlled switch 15 is shown in FIG. 1 in the operating position 51 by solid lines. The operator-controlled switch 15 can also assume an off position 52 as well as several start positions, namely, a warm start position 53 and a cold start position 54.

In the operating position 51, the position of the throttle flap 13 is adjusted by the operator via the throttle lever 6. The choke flap 14 is in the completely open position. In the off position 52, a short circuit switch (not shown in FIG. 1) of the engine 10 is closed so that the ignition of the engine 10 is interrupted. In the warm start position 53 and in the cold start position 54, the throttle flap 13 and the choke flap 14 are set in fixedly pregiven positions via the operator-controlled switch 15. In this way, an adequate fuel quantity is made available for starting the engine 10 at low ambient temperatures or at high ambient temperatures or when the engine is warm.

The operator-controlled switch 15 can be shifted by the operator between the different positions as indicated by the double arrow 16. From the warm start position 53, the operator-controlled switch 15 is moved into the operating position 51 with the actuation of the throttle lever 6.

As shown in FIG. 2, and for starting the engine 10, a start device 17 is provided, which, for example, can be a spring-start device or an electrically-driven start device. The start device 17 coacts with a fan wheel 18 which moves cooling air for the engine 10 and is connected to the crankshaft 19 of the engine so as to rotate therewith. The crankshaft 19 is rotatably driven by a piston 20. The piston 20 is reciprocally journalled in a cylinder 25 of the engine 10. An ignition module 21 is provided as an ignition device which is fixed to the cylinder 25 of the engine 10 and is arranged on the outer periphery of the fan wheel 18. For generating the ignition energy, magnets are mounted on the fan wheel 18 or a separate generator can be provided for this purpose. The ignition module 21 is connected to a spark plug 22 which projects into the combustion chamber of the engine 10. The crankshaft 19 is connected to a drive sprocket 24 via a centrifugal clutch 23 and the drive sprocket 24 then drives the saw chain 9.

As shown in FIG. 3, the engine 10 has a crankcase 26 which is threadably connected to the cylinder 25 by attachment screws 28. The crankcase 26 is made of plastic. The crankcase 26 has bushings 27 for facilitating the threaded connection and the attachment screws 28 threadably engage in the bushings 27.

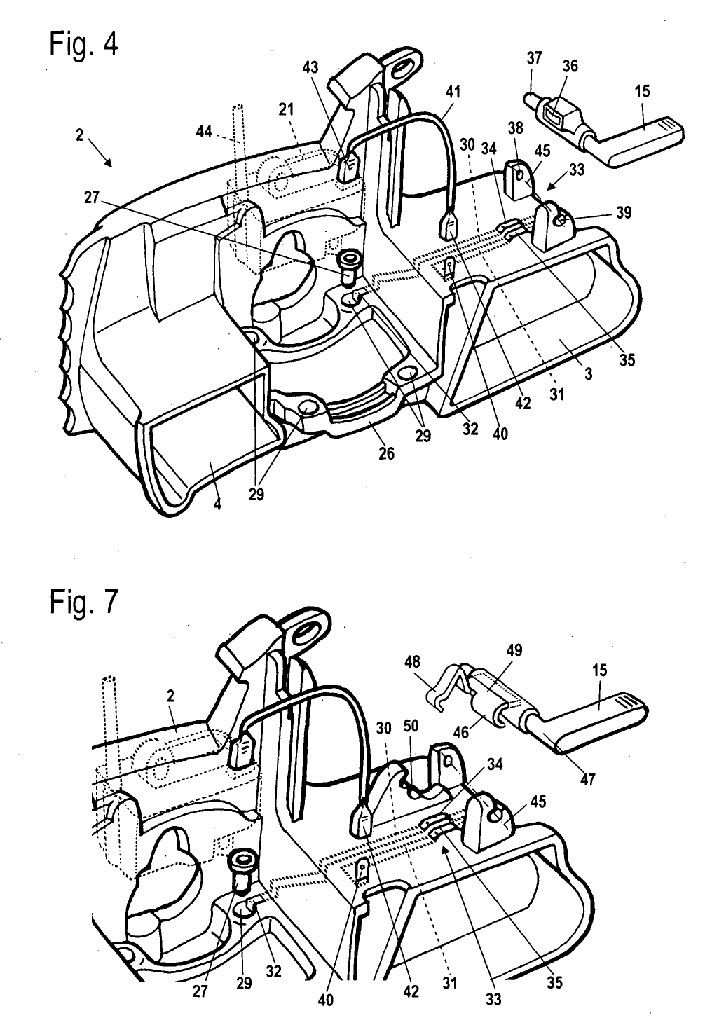

In FIG. 4, one of the bushings 27 is shown schematically. As shown, the bushings 27 are mounted fixedly in receptacles 29 of the crankcase 26. The bushings 27 are advantageously injection molded into the crankcase 26.

As shown in FIG. 4, the crankcase 26 is formed on the motor housing 2. The fuel tank 3 and the lubricant tank 4 are integrated into the motor housing 2.

In the off position 52, the operator-controlled switch 15 closes a short circuit switch 33 shown in FIG. 4. The operator-controlled switch 15 is formed on a switch shaft 37 which is pivotally journalled about a pivot axis 45 in bearings 38 and 39 on the upper side of the fuel tank 3 on the motor housing 2. A cam 36 is arranged on the switch shaft 37 and at least partially comprises electrically-conducted material. Electric lines run on the upper side of the fuel tank 3 and these lines are configured as stamped conductors 30 and 31 and are embedded in the material of the motor housing 2. In the region of the short circuit switch 33, a first contact 34 is formed on the first stamped conductor 30 and a second contact 35 is formed on the second stamped conductor 31. The contacts 34 and 35 are formed by respective segments of the corresponding stamped conductors (30, 31) and these segments project out from the material of the motor housing 2. The first stamped conductor 30 runs from contact 34 to a receptacle 29 of a bushing 27. A ground contact 32 is formed on the stamped conductor 30 at the receptacle 29. The stamped conductor 30 projects into the receptacle at the ground contact 32 and so electrically contacts a bushing mounted in the receptacle 29. The stamped conductor 30 is completely embedded in the material of the motor housing 2 between the ground contact 32 and the contact 34.

The second stamped conductor 31 connects the second contact 35 to a contact blade 40 whereat the stamped conductor 31 advantageously projects approximately perpendicularly out of the material of the motor housing 2. The contact blade 40 connects to a connecting plug 42 of a connecting cable 41. The other end of the connecting cable 41 is connected to the ignition module 21 with a connecting plug 43. The ignition module 21 has a connecting cable 44 for connecting to a spark plug 22.

The two contacts 34 and 35 are arranged mutually adjacent on the upper side of the motor housing 2. In the off position 52 of the operator-controlled switch 15, the two contacts 34 and 35 are connected to each other via the cam 36. This is shown schematically in FIG. 5. The cam 36 lies against the two contacts 34 and 35.

The short circuit switch 33 is open in the operating position 51 shown in FIG. 6. The cam 36 lies at a spacing to the two contacts 34 and 35 because of the pivot movement of the switch shaft 37 about the pivot axis 45. The ignition of the engine 10 is not short circuited in the operating position 51 of the operator-controlled switch 15 so that an ignition spark can be generated in the combustion chamber of the engine 10.

FIG. 7 shows an embodiment for the short circuit switch 33. The same reference characters are used for the same components as in FIG. 4. The short circuit switch 33 shown in FIG. 7 has a switch shaft 47 on which an electrically conductive cam 46 is mounted. A latch spring 48 is provided for fixing the different positions of the operator-controlled switch 15 and the switch shaft 47. The latch spring 48 is configured with the cam 46 on a common sheet metal part 49. The latch spring 48 coacts with a latch contour 50 formed on the upper side of the motor housing 2 in order to fix the operating position 51, the off position 52, the warm-start position 53 and the cold-start position 54. The sheet metal part 49 is stamped from a planar sheet metal piece and bent. The cam 46 of the sheet metal part 49 is so bent that the two contacts 34 and 35 are contacted by the cam 46 only in the off position 52 of the operator-controlled switch 15.

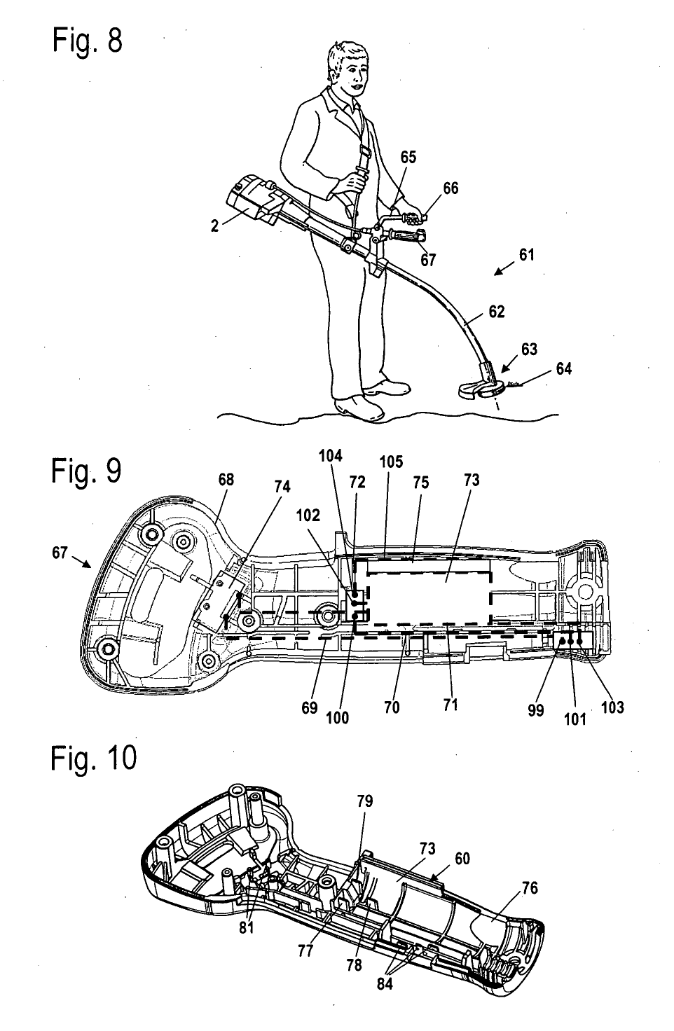

FIG. 8 shows a brushcutter 61 as a further embodiment for a portable handheld work apparatus. The brushcutter 61 has a guide tube 62 having a motor housing 2 on a first end thereof and a filament cutter head mounted on the other end thereof. A rotatingly driven cutting filament is provided as a work tool on the filament cutter head 63. A grip tube 65 is fixed to the guide tube 62 and a left handle 66 and a right handle 67 are mounted on the grip tube 65 for guiding the brushcutter 61 during operation. In the embodiment, an operator-controlled switch (not shown), a throttle lever (not shown) and a short circuit switch are provided on the right handle 67.

FIG. 9 schematically shows the configuration of the right handle 67. The right handle 67 has a handle housing 68 in which a microswitch 74 is mounted and this microswitch forms a short circuit switch. In the right handle 67, a heating element 75 is mounted which is arranged on a heat distribution element 73. Electric lines (69, 70, 71, 72) are provided for electrically contacting the heating element 75 and the microswitch 74.

The electric line 69 connects the microswitch 74 to a connector 99. The first line 69 is thereby the short circuit line. A second line 70 connects a connector 100 to a connector 101. A third line 71 functions as a ground line and connects the microswitch 74 to the heat distribution element 73, to a connector 102 and, via the heat distribution element 73, to a connector 103. The heat distribution element 73 contacts the heating element 75 at one end. At the opposite-lying end, the heating element 75 is contacted by a connector 105 which is connected via a line 72 to a connector 104.

The three connectors (99, 101, 103) connect the first handle 67 to the engine 10 or to a control with the engine 10 being mounted in the motor housing 2. The three connectors (100, 102, 104) are formed on contact blades (77, 78, 79) shown in FIG. 10 and connect to a line guided in the grip tube 65. This is shown in detail in FIG. 13.

As FIG. 13 shows, three connecting contacts 87 are arranged on the grip tube 65 and are each configured as retaining contact prongs spring-biased toward each other and clampingly engage respective ones of contact blades (77, 78, 79). The connecting contacts 87 are connected to the left handle 66 via electric lines guided in the grip handle 65. A further heating element and a switch are mounted in the left handle 66. The switch is for switching on and switching off the handle heater for both handles 66 and 67. When switching on the handle heater, the lines, which are connected to the connectors 100 and 104, are electrically connected to each other so that a heater voltage from the second line 70 is applied to the heating element 75.

The grip handle 65 is pushed in a joining direction 88 into the handle housing 68. As shown in FIG. 13, the contact blades (77, 78, 79) are aligned in the joining direction 88. A bevel 86 is formed on the end of each of the contact blades (77, 78, 79) facing toward the connecting contacts 87. The bevel 86 ensures that the two retaining contact prongs of each connecting contact 87 engage on both sides about the corresponding contact blade (77, 78, 79). For contacting the contact blades (77, 78, 79), only the grip tube 65 needs to be pushed into the right handle 67 in the joining direction 88. In this operation, the connecting contacts 87 are pushed over the contact blades (77, 78, 79) and thereby establish an electric connection.

The handle housing 68 is advantageously coated at least partially by a soft material which forms a jacket. The soft material can, for example, be a thermoplastic elastomer. The material of the jacket can, advantageously, pass via at least one inlet opening into the interior of the handle housing 68 and so form a seal for sealing off electric components.

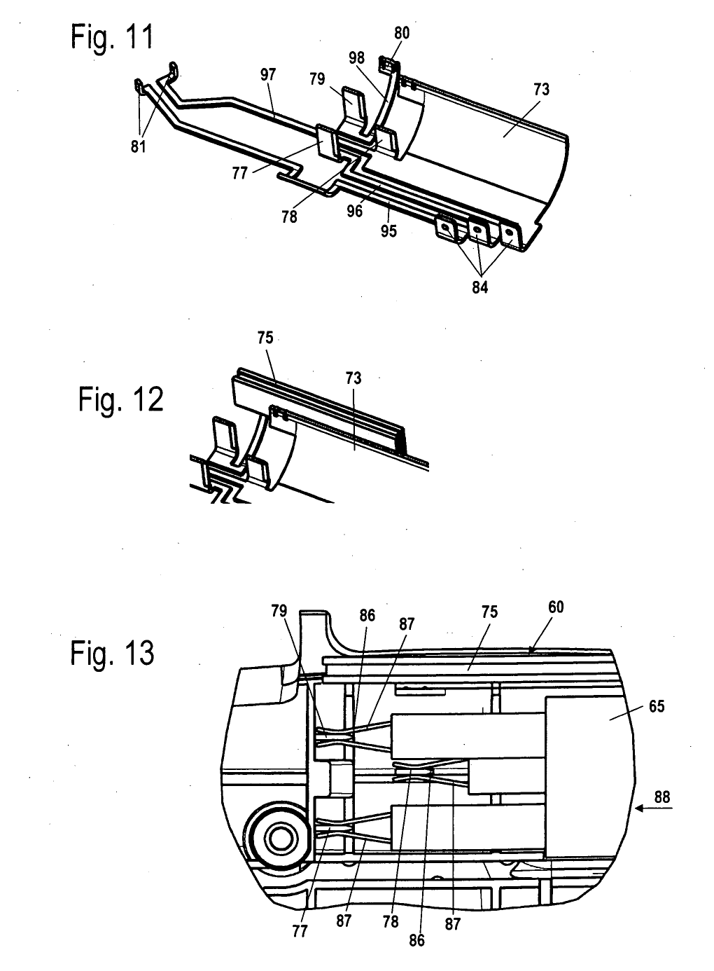

For fixing the heating element 75, a receptacle pocket 60 is formed between the region of the heat distribution element 73, which projects upwardly from the material of the housing half shell 76, and the wall of the housing half shell 76 as shown in FIGS. 10 and 13. The connector 105 (FIG. 9) is provided next to the wall of the housing half shell 76 and this connector 105 is configured as a clamp contact 80 (FIG. 11). The heat distribution element 73 electrically contacts the heating element 75 as well as ensures an adequate heat transfer to the heating element 75. The clamp contact 80 lies on the opposite-lying end of the heating element 75. The heating element 75 is therefore clamp held between the clamp contact 80 and the heat conductive element 73. Further means for fixing the heating element 75 are not needed.

FIG. 11 shows the configuration of the lines 69 to 72 as stamped conductors. The first conductor 69 is formed as stamped conductor 95 which connects a contact pin 84 to a contact blade 81. The second line 70 is configured as a second stamped conductor 96 and connects a further contact pin 84 to a contact blade 77. The third line 71 is configured as a third stamped conductor 97 and is configured as one piece with the heat distribution element 73. The third stamped conductor 97 has a third contact pin 84, a contact blade 78 and a contact blade 81 which are connected to each other via the third stamped conductor 97. A fourth stamped conductor 98 forms the fourth line 72 and connects the clamp contact 80 to the contact blade 79. The stamped conductors (95, 96, 97, 98) are coated for the most part by material of the handle housing 68 as shown in FIG. 10. Only the contact pins 84, the contact blades (77, 78, 79, 81) and the section of the heat distribution element 73, which delimits the receptacle pocket 60, project from the material of the handle housing 68 into the interior thereof. All of the lines, which are needed in the handle housing 68 for connecting electric components, are formed by the stamped conductors (95, 96, 97, 98) so that a placement of lines in the handle 67 is not needed.

In the embodiment, the heat distribution element 73 is configured as one piece with the stamped conductor 97. A further section of the heat distribution element 73 can be provided, for example, in the second housing half shell of the handle 67. This additional section of the heat distribution element 73 can be configured as a separate component, for example, as a stamped bent sheet metal piece.

An electric line, which is embedded in a housing component, for connecting to an electric component of a handheld portable work apparatus can also be provided in portable handheld work apparatus which do not have an internal combustion engine as a drive motor, rather, for example, an electric motor.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
a work tool;
an internal combustion engine for driving said work tool;
said engine including a cylinder and a crankcase connected to said cylinder;
said engine further including an ignition system;
a housing component made at least partially of an electric non-conductive material;
at least one electric line;
at least one electric component provided on said housing component and being electrically connected to said electric line; and,
said electric line having at least one segment embedded in said housing component.

2. The portable handheld work apparatus of claim 1, wherein said housing component is made at least partially of plastic; and, said segment is injection molded into the plastic of said housing component.

3. The portable handheld work apparatus of claim 2, wherein said embedded segment of said electric line is configured as a stamped conductor.

4. The portable handheld work apparatus of claim 1, further comprising at least one contact arranged on said embedded segment so as to project out from said material of said housing component to facilitate an electric contact thereto.

5. The portable handheld work apparatus of claim 4, further comprising a connecting component joinable with said housing component along a joining direction; said connecting component including a connecting contact; and, said contact of said embedded segment being configured as a blade contact for connecting to said connecting contact of said connecting component and being aligned in said joining direction of said connecting component.

6. The portable handheld work apparatus of claim 1, wherein said electric line is a first electric line; and, wherein said apparatus further comprises a second electric line having a segment thereof embedded in said housing component; said electric component is a switch including first and second contacts arranged on corresponding segments of said first and second electric lines; and, a bridging element movably journalled on said housing component for coacting with said first and second contacts.

7. The portable handheld work apparatus of claim 6, wherein said first and second contacts are mutually adjacent and said bridging element is an electrically conductive cam.

8. The portable handheld work apparatus of claim 7, further comprising a pivotally journalled switch shaft movable to an operating position, an off position and a start position; and, said bridging element being mounted on said switch shaft.

9. The portable handheld work apparatus of claim 8, further comprising a latch spring integrated into said switch shaft.

10. The portable handheld work apparatus of claim 9, wherein said bridging element and said latch spring are formed as one piece from bent sheet metal.

11. The portable handheld work apparatus of claim 1, wherein said housing component is a motor housing of said work apparatus.

12. The portable handheld work apparatus of claim 11, further comprising a tank for holding an operating means and said tank being integrated into said motor housing; and, said embedded segment being arranged so as to run in a wall of said tank.

13. The portable handheld work apparatus of claim 11, said crankcase of said engine being formed onto said motor housing.

14. The portable handheld work apparatus of claim 11, wherein said electric line is a first electric line; and, wherein said apparatus further comprises a second electric line having a segment thereof embedded in said housing component; said electric component is a short circuit switch including first and second contacts arranged on corresponding segments of said first and second electric lines; said short circuit switch establishes a connection between said contacts when said switch is in an off position; and, said first contact is connected to a ground contact and said second contact is connected to said ignition system.

15. The portable handheld work apparatus of claim 14, wherein said ground contact is connected to said cylinder of said engine.

16. The portable handheld work apparatus of claim 14, wherein said crankcase has a bushing; said apparatus further comprises an attachment screw threadably engaged with said bushing for fixing said cylinder; and, said first segment projects up to said bushing so as to be electrically conductively connected to said cylinder via said bushing.

17. The portable handheld work apparatus of claim 16, wherein said segment of said first electric line is embedded in said motor housing between said first contact and said bushing.

18. The portable handheld work apparatus of claim 14, wherein said second contact is connected to a contact blade for connecting to a connecting cable for said ignition device.

19. The portable handheld work apparatus of claim 18, wherein said second electric line between said second contact and said contact blade is embedded in said motor housing.

20. The portable handheld work apparatus of claim 1, further comprising a heat distribution element; and, said electric component is a heating element arranged on said heat distribution element.

21. The portable handheld work apparatus of claim 20, wherein at least one section of said heat distribution element is configured as one piece with said embedded segment of said electric line and mechanically fixes and electrically contacts said heating element.

22. The portable handheld work apparatus of claim 21, wherein said housing component is a handle housing of a handle.

23. The portable handheld work apparatus of claim 22, wherein said handle has a connecting plug for connecting to a connecting cable and has contact blades for connecting to connecting contacts; said electric line is a first electric line; and, wherein said apparatus has a plurality of said electric lines arranged between: said connecting plug, corresponding ones of said contact blades and said electric component; and, said plurality of electric lines is embedded in said handle housing.
